(19) United States
(12) Patent Application Publication
(10) Pub. No.: US 2004/0222927 A1
(43) Pub. Date: Nov. 11, 2004

(54) Surface mountable antenna

(76) Inventors: Paul Robert Hoffman, San Diego, CA (US); Ken Kaskoun, La Jolla, CA (US); Markus Liebhard, Oakland, CA (US); Peter McCaffrey, San Diego, CA (US); Sebastian Rowson, San Diego, CA (US)

Correspondence Address: FOLEY & LARDNER, P.O. BOX 80278, SAN DIEGO, CA, 92138-0278, US

(21) Appl. No.: 10/431,761

(22) Filed: May 8, 2003

(51) Int. Cl. H01Q 1/24

(52) U.S. Cl. 343/702; 343/700 MS

(57) ABSTRACT

A surface-mountable antenna that includes a severable portion is described.

### FIELD OF THE INVENTION

The present invention relates generally to the field of manufacturing components and more particularly to the manufacture of an antenna that couples metal components to plastic components.

### BACKGROUND

Many manufacturing processes utilize metal elements in their manufacture. The metal elements may be structurally unstable, resulting in non-secure structures that break or deteriorate easily during and after manufacture. A more secure structure that does not break or deteriorate during and after manufacture is desired.

### SUMMARY OF THE INVENTION

The present invention addresses the need for a metal/plastic component which allows for a much more secure assembly by creating additional solderable surfaces, which when strategically placed on the metal/plastic components is soldered to other elements to ensure a secure attachment at minimal expense, while decreasing the necessity for maintenance in the future.

In one embodiment, a metal sheet is die-cut in order to apply to a plastic frame for use as an antenna. The antenna may be applied to, and bent around the plastic frame. In one embodiment, feed/ground portion(s) and/or solderable portion(s) of the antenna are applied to and/or bent around the plastic frame.

The antenna may be stamped out, cut out, or routed out of a sheet of metal. A cut metal may be bent to fit the plastic frame as specified. A bent metal may be placed and secured onto the plastic frame via insert-molding, heat-staking, or snap-fitting, at which point a secondary operation of severing the bent metal may take place, and the bent metal is fitted around the plastic frame to form additional solderable points. As described in greater detail below, the antenna is adhered to additional components via the additional solderable surfaces to increase the security of the antenna while reducing maintenance and production costs.

The process detailed in the present invention may be utilized for various different metal/plastic components in a similar manner to yield similar benefits to those derived during the manufacture of an antenna. The invention described herein maintains tolerances, mechanical robustness, and performance, with a reduction of applicable manufacturing steps, along with an increase of manufacturing solidity and security.

In one embodiment, a capacitively coupled dipole antenna body may comprise a body, the body including a feed connection portion used for connecting to a feed; a ground connection portion used for connecting to a ground; and a severable surface mount portion used for connecting to a surface. The antenna may comprise a frame, wherein the body is coupled to the frame, and wherein the surface mount portion is severed from the body. The antenna may comprise a frame, wherein the body is coupled to the frame, wherein the surface mount portion is severed from the body; and wherein the surface mount portion is severed from the body after the body is coupled to the frame.

In one embodiment, an antenna may comprise a ground portion; a feed portion; mounting means for mounting the antenna to a surface. The antenna may comprise a frame, the antenna coupled to the frame. The he mounting means may be severable from the antenna. The he antenna may comprise a capacitively coupled dipole antenna.

In one embodiment, a method of manufacturing an antenna, may comprise the steps of forming a dielectric frame; forming a metal element; coupling the dielectric frame to the metal element; and severing a metal portion from the metal element. The antenna may comprise a capacitively coupled dipole antenna. The metal element may be formed by etching. The metal element may be formed by routing. The metal element may be formed by molding. The dielectric frame may be coupled by heat-staking to the metal element. The dielectric frame may be coupled by snap-fitting to the metal element. The antenna may comprise a capacitively coupled dipole antenna.

In one embodiment, a device may comprise an antenna body, the antenna body including a feed connection portion; a ground connection portion; and a severable surface mount portion for connecting to a surface. The device may further comprise a frame, wherein the body is coupled to the frame, and wherein the surface mount portion is severed from the body. The device may further comprise a frame, wherein the body is coupled to the frame; and wherein the surface mount portion is severed from the body after the body is coupled to the frame. The device may comprise a telecommunications device. The antenna body may comprise a capacitively coupled dipole antenna.

Other embodiments and other benefits derived there are within the scope of the appended Claims and Specification and will become apparent from a reading of the Specification.

### BRIEF DESCRIPTION OF THE DRAWINGS

FIG. 1 is a view of a metal sheet used in the manufacture of a metal/plastic component;

FIG. 2A is a top view of a dielectric frame;

FIG. 2B is a side view of the dielectric frame of FIG. 2A;

FIG. 2C is a perspective view of the dielectric frame of FIG. 2A;

FIG. 3A is a top view of the metal/plastic component resulting from the attachment of the metal sheet of FIG. 1 and the dielectric frame of FIG. 2A;

FIG. 3B is a side perspective view of the metal/plastic component of FIG. 3A;

FIG. 3C is a perspective view of the metal/plastic component of FIG. 3A;

FIG. 4A is the first half of a flow chart illustrating a process for manufacturing the metal/plastic component of FIG. 3A;

FIG. 4B is the second half of a flow chart illustrating a process for manufacturing the metal/plastic component of FIG. 3A;

FIG. 5A is a top view of the metal element of FIG. 1 after being bent to fit the plastic frame of FIG. 2A;

FIG. 5B is a side perspective view of the bent metal element of FIG. 5A;

FIG. 5C is a bottom perspective view of the bent metal element of FIG. 5A;

FIG. 6A is a top view of metal/plastic component after the metal element is attached to the dielectric frame;

FIG. 6B is a side view of the metal/plastic component of FIG. 6A;

FIG. 6C is a perspective view, from the bottom, of the metal/plastic component of FIG. 6A;

FIG. 7A is a perspective view, from the front of the metal/plastic component of FIG. 3A; and

FIG. 7B is a side perspective view, from the rear of the metal/plastic component of FIG. 3A.

### DETAILED DESCRIPTION OF THE INVENTION

In the following description, for purposes of explanation and not limitation, specific details are set forth in order to provide a thorough understanding of the present invention. However, it will be apparent that the present invention may be practiced in other embodiments that depart from these specific details. For example, although one or more of the embodiments used for explanation herein concern an antenna, the same manufacturing processes detailed herein may be practiced with other types of components. In other instances, detailed descriptions of well-known methods and devices are omitted so as to not obscure the description of the present invention with unnecessary detail.

In one or more embodiment, portions of a metal sheet are applied to the base of an adjoining plastic frame to improve secure surface-mounting of the metal sheet to other manufacturing components at lower cost and with fewer procedural steps. In one embodiment, wherein a metal sheet is relatively flexible, a plastic frame provides a rigid support during and after manufacture. In one embodiment, one or more portion(s) of the metal sheet are formed so as to be available for connecting to and/or mounting of the resulting metal/plastic component during manufacture, and one or more portion(s) of the metal sheet are formed to be available as feed and/or ground connection portion(s). In one embodiment, one or more portion(s) of the metal sheet are formed to be severable during manufacture. Although one or more portion is formed to be severable, in one embodiment, during and after manufacture it provides additional support for mounting and handling of the resulting metal/plastic component. The positions, shapes, tolerances, and applications of the resulting metal/plastic component are maintained during manufacture and may be preserved, for example, by soldering of specified solderable surfaces. The process is repeatable and efficient, which reduces manufacturing time and costs, while ensuring adequate performance of the resulting components and stronger adhesion between the combined components.

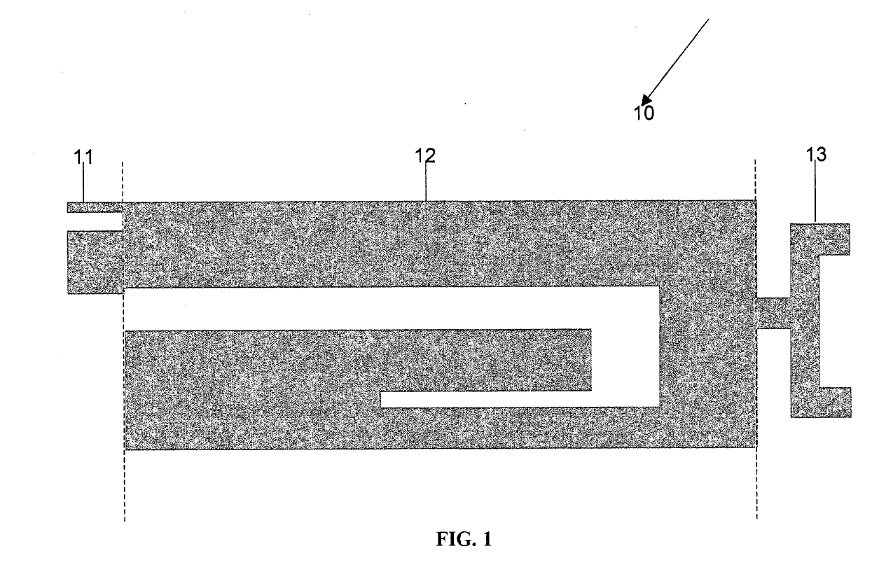

FIG. 1 illustrates a top view of a metal element 10. In one embodiment, metal element 10 includes a body 12 that comprises feed/ground portion(s) 11 and solderable portion(s) 13. As described further below, solderable portion(s) 13 are severable. Metal element 10 may be made of a conductive material including, but not limited to, a monolithic conductive material such as a metal foil or a metal sheet.

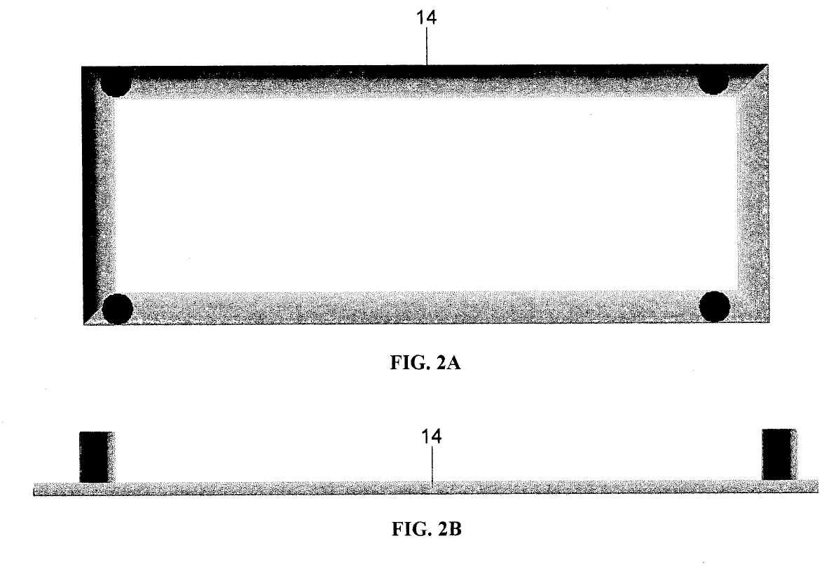

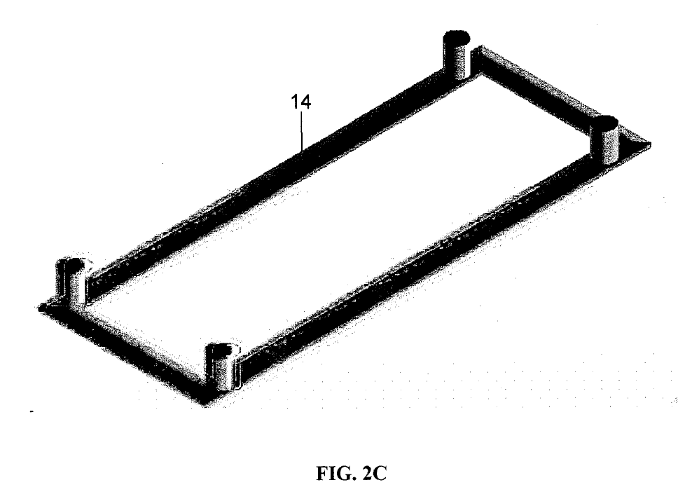

FIG. 2A illustrates a top view of a dielectric frame 14. The frame 14 may be made of a dielectric material including, but not limited to, a plastic, a variety of ceramic, or another non-conductive material.

FIG. 2B illustrates a side view of dielectric frame 14 of FIG. 2A.

FIG. 2C illustrates a perspective view of dielectric frame 14 of FIG. 2A to provide additional insight concerning the frame's general proportions. Other dimensions and other proportions are within the scope of the present invention.

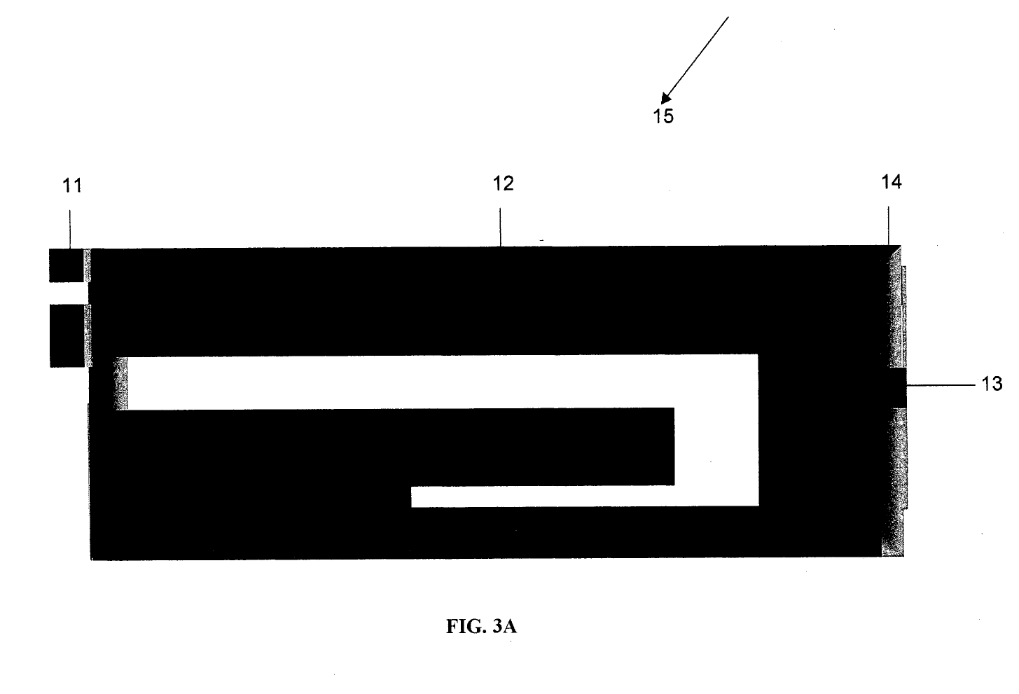

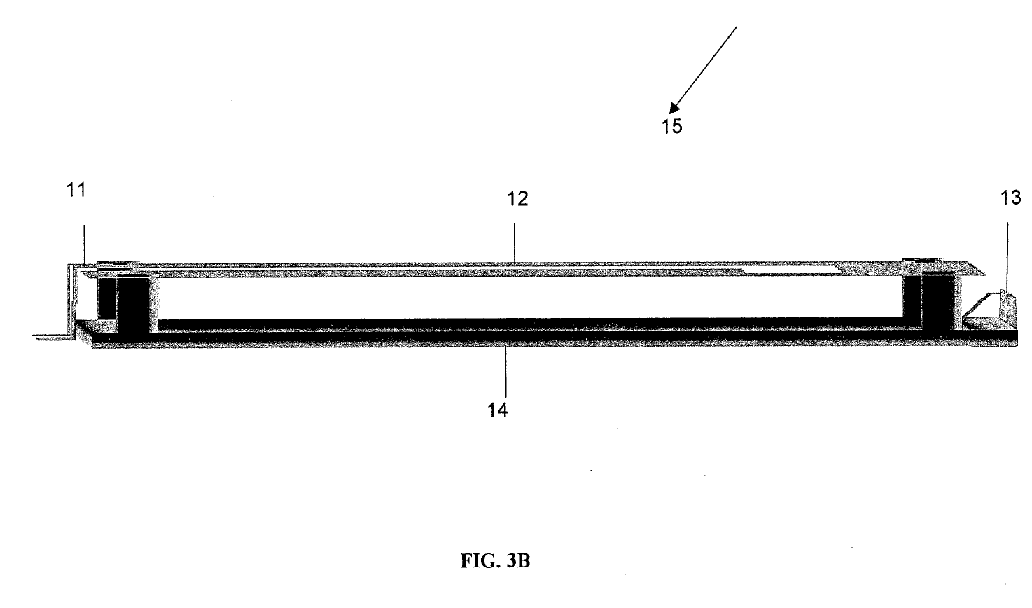

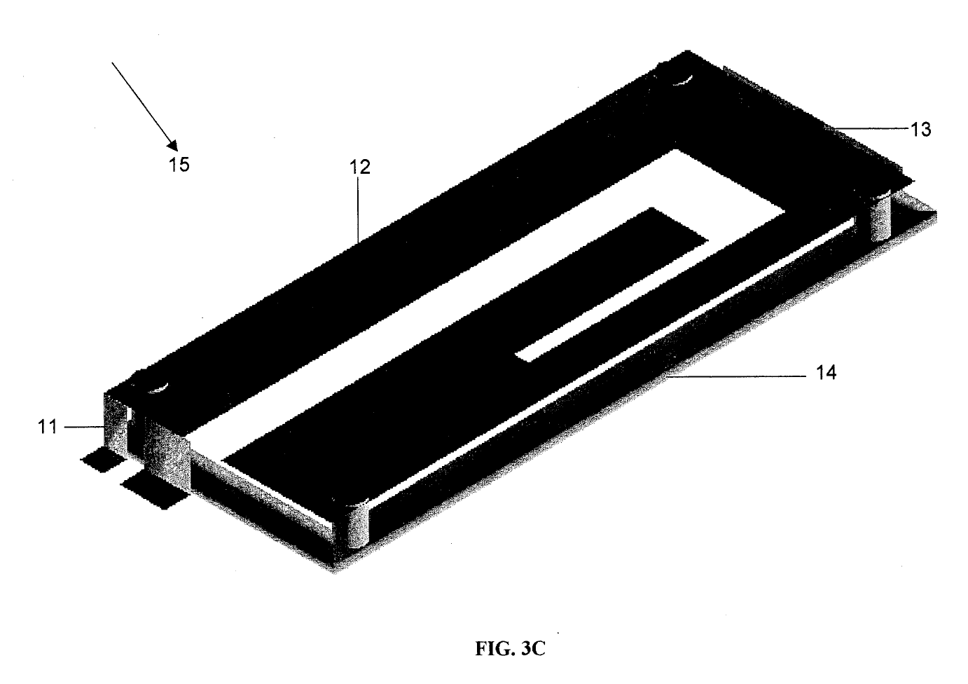

FIG. 3A illustrates a top view of a metal/plastic component 15 in a finished product stage. In one embodiment, metal element 10 of FIG. 1 is insert-molded, heat-staked, or snap-fitted to dielectric frame 14 of FIG. 2, to comprise a metal/plastic component 15. In one embodiment, one or more portion of metal element 10 effectuates use of metal element 10 as an antenna, for example, as a capacitively coupled dipole antenna described in commonly assigned U.S. patent application Ser. No. 10/298,870, filed Nov. 18, 2002, which is herein incorporated by reference.

FIG. 3B illustrates a side perspective view of metal/plastic component 15 of FIG. 3A to provide additional insight concerning the component's general proportions. In the embodiment of FIG. 3B, solderable portion(s) 13 of metal element 10 are bent around dielectric frame 14, and feed/ground portion(s) 11 are bent into an appropriate position for mounting to a desired component, for example, surface mounting to a circuit board and/or a substrate of a telecommunications device that provides for reception and transmission of signals.

FIG. 3C illustrates a side perspective view of metal/plastic component 15 of FIG. 3A to provide additional insight concerning the component's general proportions.

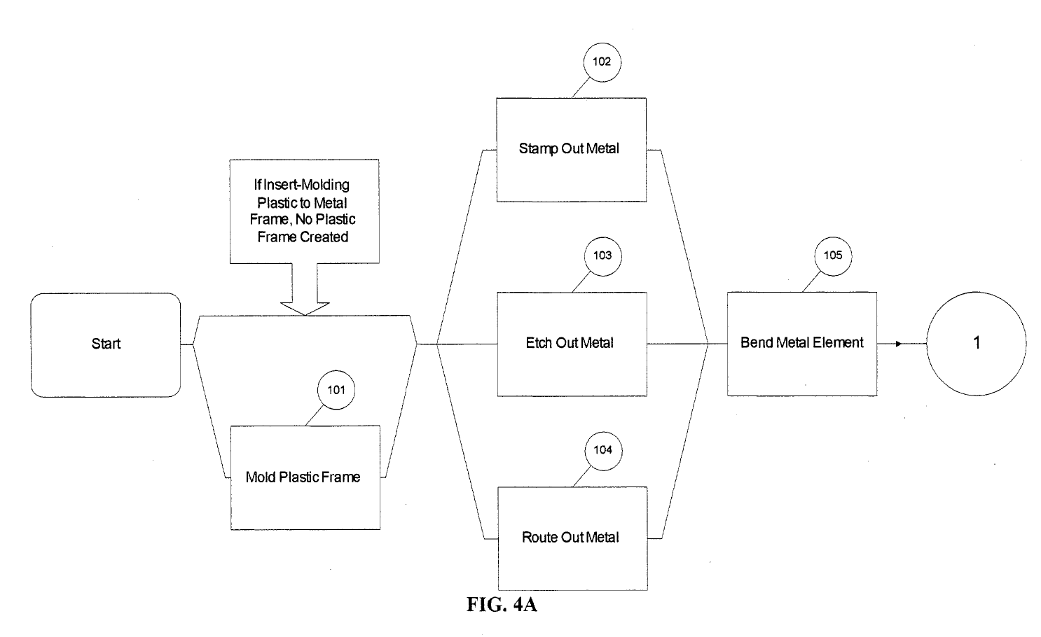

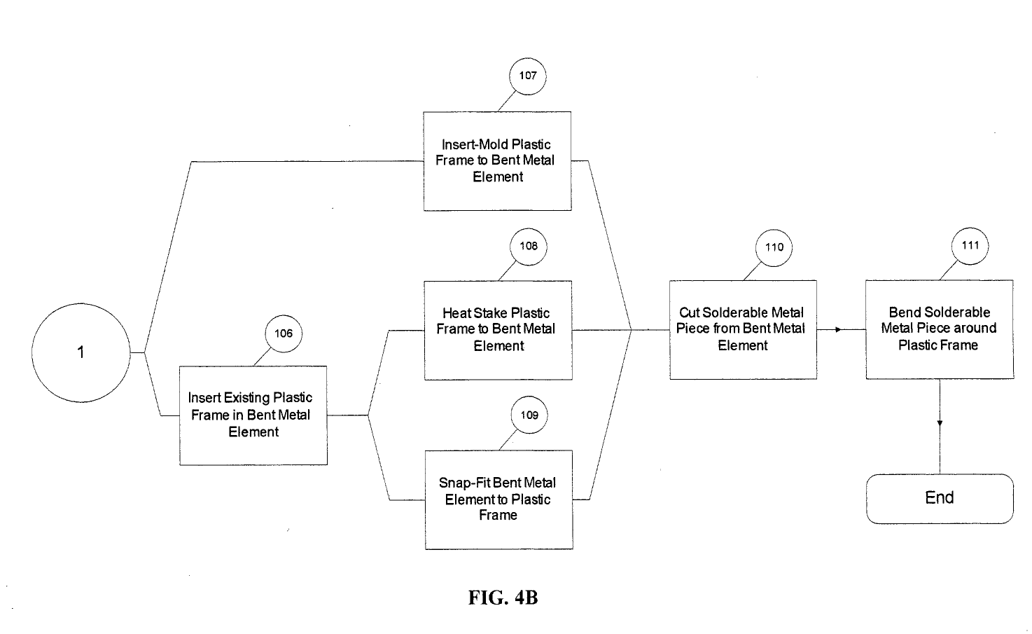

FIGS. 4A and 4B illustrate a flowchart for manufacturing a metal/plastic component 15 in accordance with methods disclosed herein. Each step within the process is discussed more filly below with reference to remaining Figures.

The first step 101 comprises molding dielectric component 14 in preparation for mounting a metal element 10 during a heat-staking or snap-fitting attachment process step. In the event that an insert-molding process step is used, molded dielectric component via step 101 is not applied. In step 102, metal element 10 is stamped out of a metal sheet, to define metal feed/ground portion(s) 11, metal body 12, and solderable portion(s) 13. Step 103 allows for a secondary process step option of etching metal element 10 out of the sheet metal, and Step 104 provides a third process step option in which metal element 10 is routed out of sheet metal. Implementation of steps 102, 103, and 104 is understood to be within the scope and skill of those skilled in the art. After steps 102, 103, or 104, the newly-cut metal element 10 is bent in accordance with predetermined specifications in order to fit about dielectric frame 14.

Note that after step 105 of flowchart 4A, connector 1 (the “1” in the circle at the far right of flowchart 4A) refers to a continuation to flowchart 4B. Step 106 defines the insertion of a dielectric frame 14 into the bent metal element 10. Step 106 is not applicable to adhesion process insert-molding, as step 101 was skipped. Step 107 is applied when the dielectric material is insert-molded to metal body 12 of metal element 10, creating an as yet nonexistent dielectric frame 14. In one alternative process of adhesion, step 108 heat-stakes dielectric frame 14 to metal body 12 of bent metal element 10. In another alternative adhesion process, step 109 provides the option of snap-fitting metal body 12 of metal element 10 to dielectric frame 14. In step 110, after performing adhesion process 107, 108 or 109, solderable portion(s) 13 are cut away from metal body 12. Finally, in step 111, solderable portion(s) 13 is bent around dielectric frame 14 to create solderable metal/plastic component 15.

It is identified that in one or more embodiment, one or more of the steps described above may be performed in a different order and not depart from the desired invention, for example, in one embodiment, steps 110 and 111 may be performed in a reverse order to that described. The final product(s) derived from the process illustrated via FIGS. 4A and 4B may vary and dielectric frame 14 and metal element 10 may be composed of a wide variety of materials, and with different dimensions. It is identified that in one embodiment, with solderable portion(s) 13 severed or cut away, metal body 12 is electrically isolated from connections that the surface mounting portions(s) 13 are to be soldered to.

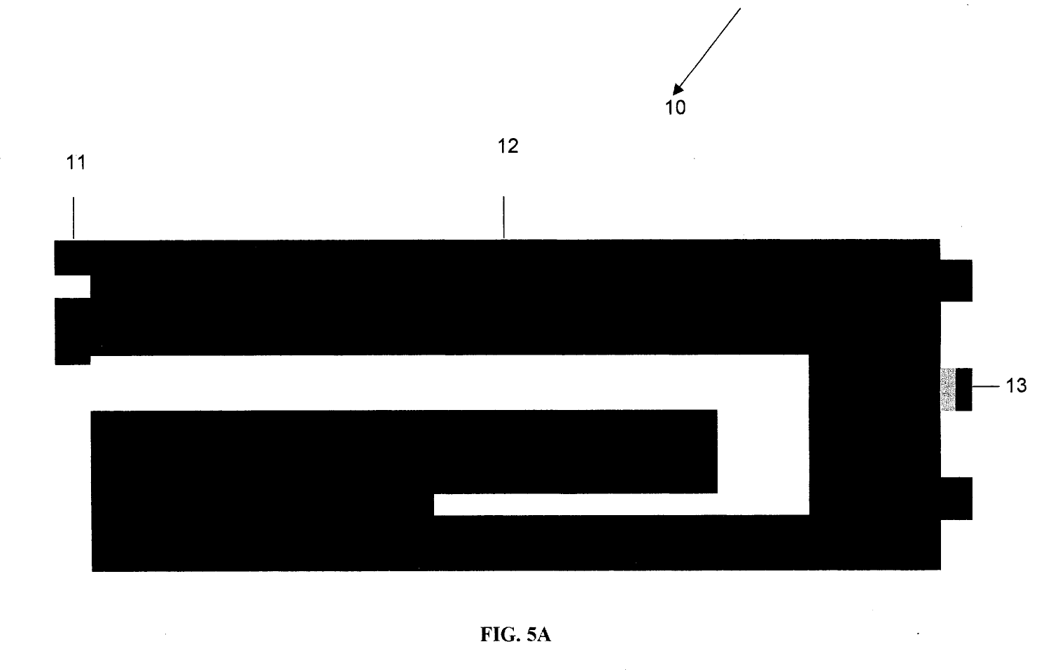

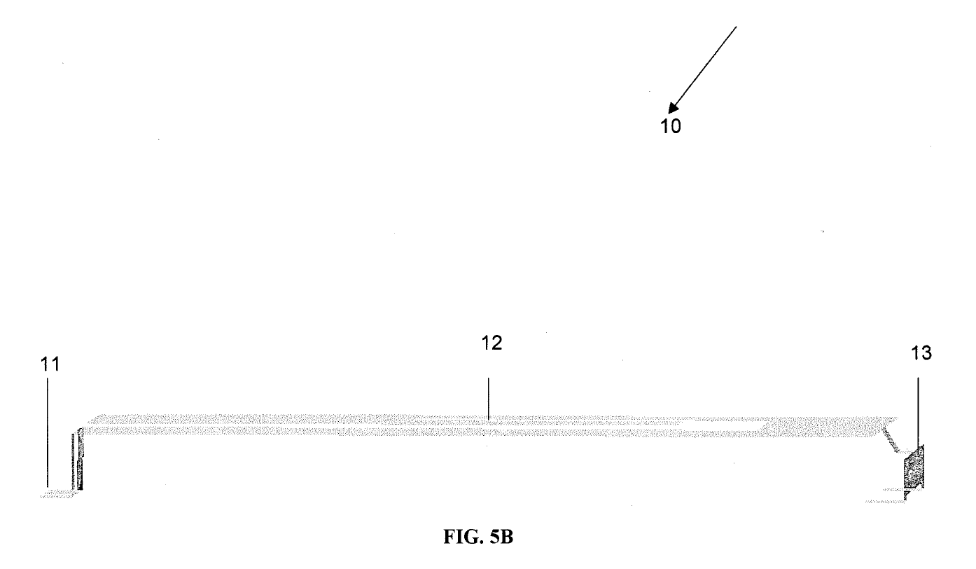

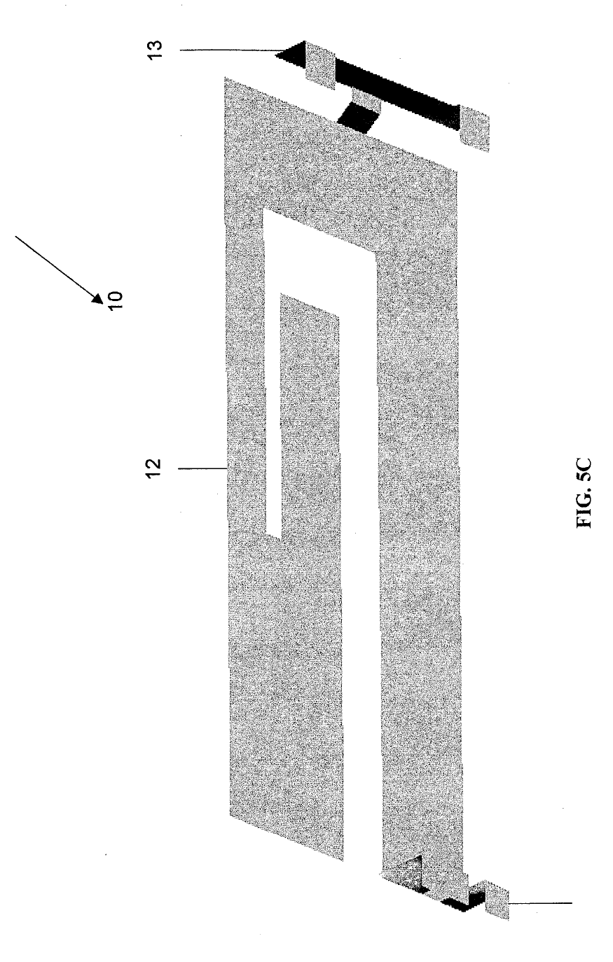

FIG. 5A illustrates a top view of metal element 10, produced in accordance with step 105. While in one embodiment metal element 10, comprised of metal feed/ground portion(s) 11, metal body 12, and solderable portion(s) 13, comprise a surface-mountable antenna, an unlimited combination of materials and dimensions can be used to define element 10 to create an equally unlimited variation of metal/plastic component 15.

FIG. 5B illustrates a side perspective view of metal element 10 of FIG. 5A to provide additional insight concerning the general proportions of element 10.

FIG. 5C illustrates a bottom perspective view of metal element 10 of FIG. 5A to provide additional insight concerning the general proportions of element 10.

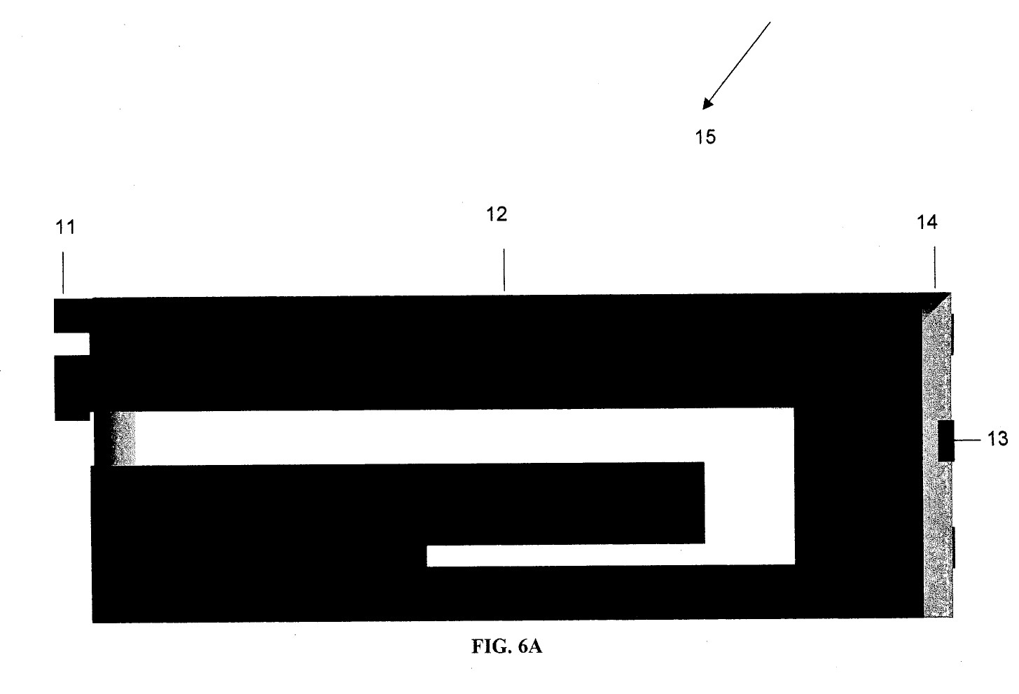

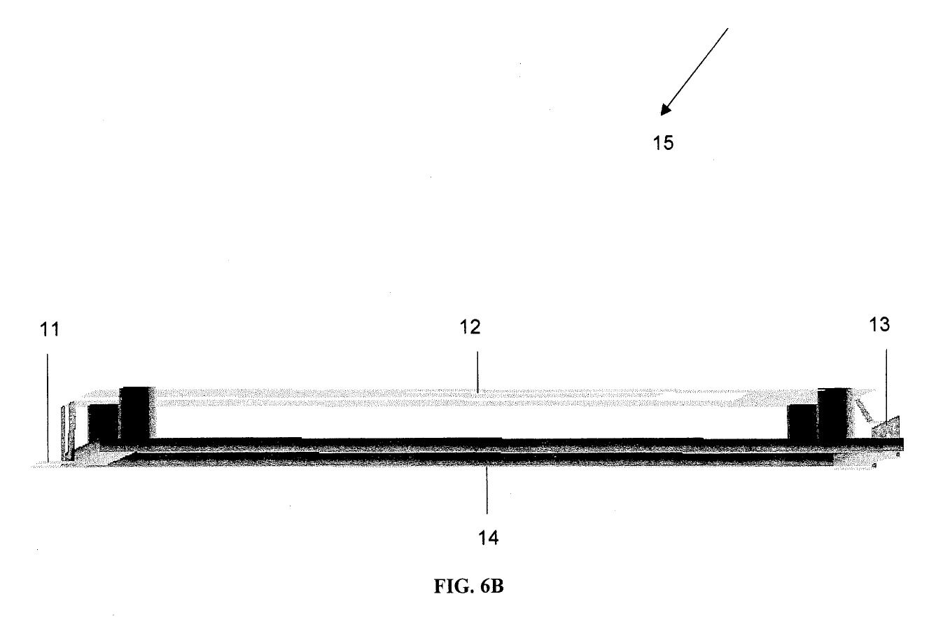

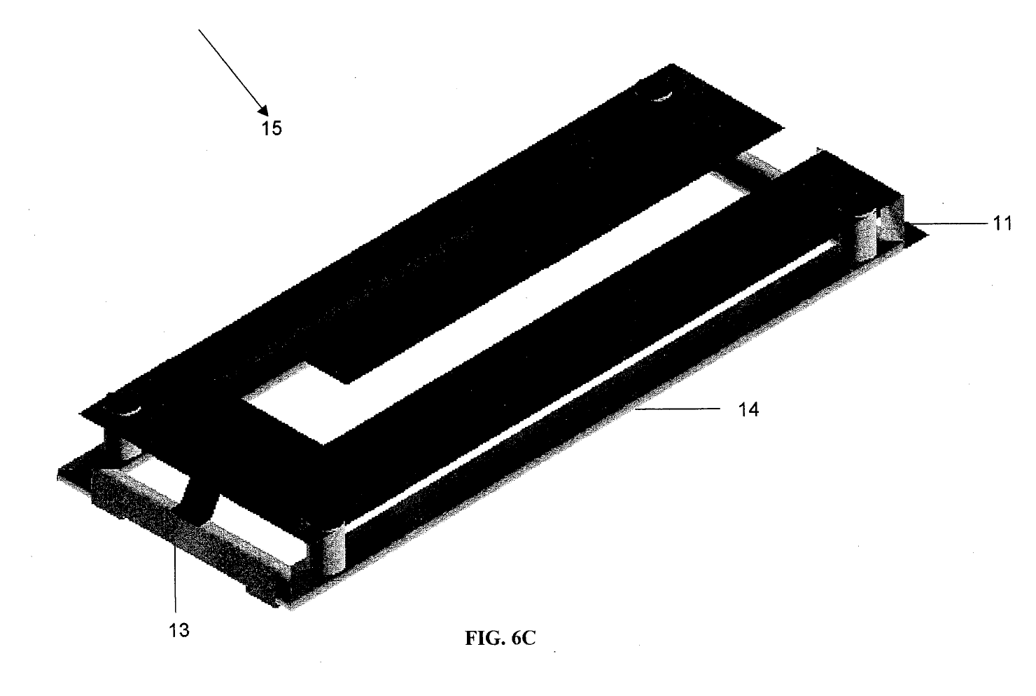

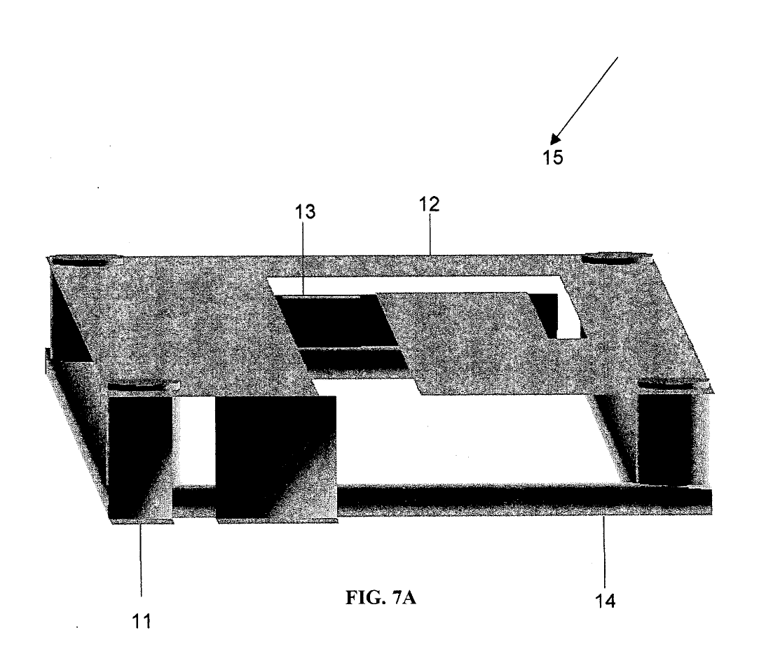

FIG. 6A illustrates a top view of metal element 10 and dielectric frame 14 produced in accordance with one embodiment of the invention described above during steps 107, 108, or 109. While the combination of metal element 10, comprised of metal feed/ground 11, metal body 12, and solderable portion(s) 13, and dielectric frame 14 illustrate a specific embodiment of a surface-mountable antenna, an unlimited combination of materials and dimensions can be applied to element 10 and dielectric frame 14 to create an equally unlimited variation of metal/plastic component 15.

FIG. 6B illustrates a side view of metal element 10 adhered to dielectric frame 14 of FIG. 6A to provide additional insight concerning general proportions of metal/plastic component 15.

FIG. 6C illustrates a perspective view of metal element 10 adhered to dielectric frame 14 of FIG. 6A to provide additional insight concerning general proportions of metal/plastic component 15. Furthermore, from the perspective view, solderable portion(s) 13 are displayed as still attached to metal body 12, as the illustrated example has yet to proceed to step 110 in which these portions of metal element 10 are severed.

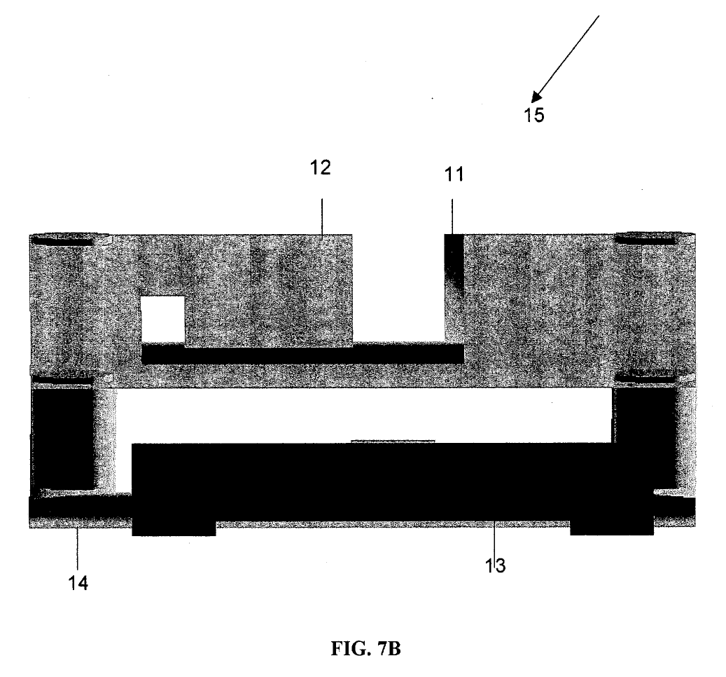

FIG. 7A illustrates a front perspective view of a surface-mountable antenna, produced in accordance with principles described above.

FIG. 7B illustrates a rear perspective view of a surface-mountable antenna produced in accordance with principles described above.

Thus, it will be recognized that the preceding description embodies one or more invention that may be practiced in other specific forms without departing from the spirit and essential characteristics of the disclosure and that the invention is not to be limited by the foregoing illustrative details, but rather is to be defined by the appended claims.

What is claimed:

1. A capacitively coupled dipole antenna body, comprising:
a body, the body including
a feed connection portion used for connecting to a feed;
a ground connection portion used for connecting to a ground; and
a severable surface mount portion used for connecting to a surface.

2. The antenna of claim 1, further comprising a frame, wherein the body is coupled to the frame, and wherein the surface mount portion is severed from the body.

3. The antenna of claim 1, further comprising a frame, wherein the body is coupled to the frame, wherein the surface mount portion is severed from the body; and wherein the surface mount portion is severed from the body after the body is coupled to the frame.

4. An antenna, comprising:
a ground portion;
a feed portion;
mounting means for mounting the antenna to a surface.

5. The antenna of claim 4, further comprising a frame, the antenna coupled to the frame.

6. The antenna of claim 5, wherein the mounting means is severable from the antenna.

7. The antenna of claim 6, wherein the antenna comprises a capacitively coupled dipole antenna.

8. A method of manufacturing an antenna, comprising the steps of:
forming a dielectric frame;
forming a metal element;
coupling the dielectric frame to the metal element; and
severing a metal portion from the metal element.

9. The method of claim 8, wherein the antenna comprises a capacitively coupled dipole antenna.

10. The method of claim 8, wherein the metal element is formed by etching.

11. The method of claim 8, wherein the metal element is formed by routing.

12. The method of claim 8, wherein the metal element is formed by molding.

13. The method of claim 8, wherein the dielectric frame is coupled by heat-staking to the metal element.

14. The method of claim 8, wherein the dielectric frame is coupled by snap-fitting to the metal element.

15. The method of claim 8, wherein the antenna comprises a capacitively coupled dipole antenna.

16. A device, comprising:
an antenna body, the antenna body including,
a feed connection portion;
a ground connection portion; and
a severable surface mount portion for connecting to a surface.

17. The device of claim 16, further comprising a frame, wherein the body is coupled to the frame, and wherein the surface mount portion is severed from the body.

18. The device of claim 16, further comprising a frame, wherein the body is coupled to the frame; and wherein the surface mount portion is severed from the body after the body is coupled to the frame.

19. The device of claim 16, wherein the device comprises a telecommunications device.

20. The device of claim 16, wherein the antenna body comprises a capacitively coupled dipole antenna.
